(19) United States
(12) Patent Application Publication
(10) Pub. No.: US 2007/0076530 A1
(43) Pub. Date: Apr. 5, 2007

(54) Timing device with silent vibrating alarm

(76) Inventor: Mark I. Robinett, San Rafael, CA (US)

Correspondence Address: Mark Robinett, 207 Terrace Ave., San Rafael, CA, 94901, US

(21) Appl. No.: 11/526,279

(22) Filed: Sep. 25, 2006

Related U.S. Application Data
(60) Provisional application No. 60/721,616, filed on Sep. 30, 2005.

(51) Int. Cl. G04F 8/00; G04F 10/00

(52) U.S. Cl. 368/107

(57) ABSTRACT

A small personal timing device having a vibration alarm or a beeping alarm and multiple ways to program the alarms, including a meeting/interval timer, a timer with repeating option, twelve daily alarms and a stopwatch. The meeting/interval timer sends 3 unique alarms for any programmed interval between 10 minutes and 120 minutes, and it automatically resets itself for the next ½ hour or hour. The 12 alarms can be used together with the meeting/interval timer and the timer and the stopwatch. An electronic circuit is located within the housing member and includes one AAA battery for power and a micro controller unit that has been masked with a software program.

### CROSS REFERENCE TO RELATED APPLICATIONS

This application claims reference to U.S. Provisional Patent Application 60/721,616, filed Sep. 30, 2005.

### BACKGROUND OF THE INVENTION

1. Field of the Invention

This invention relates to watches and time-keeping devices that can communicate the time silently, by vibration to people without the distraction of looking at the clock or one's watch. It also relates to timing devices that help people manage time in a variety of ways besides the normal method of looking at a clock or watch.

2. Background of the Invention

Consultations with professionals have become increasingly common as more people are going to see psychotherapists, doctors, chiropractors, counselors, consultants, lawyers, personal trainers, etc. Professionals in these and related fields often have scheduled meeting times that they need to adhere to throughout their workday. In addition, people giving presentations have a need to keep track of time without looking at a clock so that they can keep focused on their material and their audience. The main time-keeping devices these professionals use to keep on their schedules are conventional clocks and watches. These time-keeping devices have the drawback of the need to look at them which, during a meeting with a patient, client or business associate, or during a presentation, can be distracting to the focus of the meeting or presentation, upsetting to the client or audience. In addition, it can bad for business, i.e. if a client notices their consultant occasionally looking at the clock he may feel the consultant is more concerned about the time than them. For some professionals, it is difficult to stay on schedule in their meetings because they want to stay focused on the client, but in doing so they risk loosing track of time and going over time which can throw off the schedule for the day or next meeting. Being able to track and know the time throughout a meeting without the need to look at a clock or watch is important in the fields of a number of consulting professionals. A watch and/or time-keeping device, which communicates the time silently, through vibration, to the professional throughout a meeting, can improve the time schedule, the quality and focus of the meeting, and client relations.

Other uses for a watch/timer that communicates the time via vibration includes people who have a hard time hearing an audible alarm, and for people with ADD (attention deficit disorder), and people who need a silent alert for medication when at work or in the theater.

### DESCRIPTION OF PRIOR ART

The most common method used today of tracking time during meetings or speeches is the visual observation of the time on a clock or watch. The problems with this method include distraction, the risk of poor client/audience relations, forgetting where one is regarding time in a meeting or talk, and the risk of running over time. Some professionals place a clock on the wall directly behind where a client or patient normally sits. The problem with this arrangement is that some clients will sit in a different location in the consultation room, and to have a number of clocks on the wall to cover all possible locations a client might sit could appear as if time is all the consultant is interested in; in other words, is a poor solution. The vast majority of professionals who hold meetings with clients use visual clocks and watches because there is no good time-keeping device available that would solve the above mentioned problems. People who give presentations must put extra effort into looking at their watch or at a clock.

There are a number prior art watches and time-keeping devices that utilize a vibration motor to communicate an alarm signal to the user. One of these watches, the Vibralite 3 (no patent), is designed for utilization by deaf people. It has a vibrating alarm and a number of alarm programming options. This watch does not have a way to track time during time intervals such as in meetings, or during a presentation or workshop.

Another watch, U.S. Pat. No. 5,861,797, has a message that comes on the watch face along with the vibration alarm. This watch is designed for people with Attention Deficit Hyperactivity Disorder (ADHD) or Diabetes.

Prior art U.S. Pat. No. 5,754,096, describes an electronic apparatus with a vibration informing function that is aimed at delivering a vibration that has the correct sensation to the wearer while conserving battery energy.

A number of prior art, U.S. Pat. No. 5,023,853, U.S. Pat. No. 4,456,387, U.S. Pat. No. 5,367,505, U.S. Pat. No. 5,282,181, describes watches or time keeping devices with a silent vibration alarm to signal an alarm time. However, this prior art all describe a single programmable alarm.

Other prior art; U.S. Pat. No. 4,321,699, U.S. Pat. No. 5,043,956, U.S. Pat. No. 5,367,505, U.S. Pat. No. 5,793,133, U.S. Pat. No. 5,861,686, and U.S. Pat. No. 5,878,004, all describe vibration motors or vibration devices to be used in a watch.

Additional prior art; U.S. Pat. No. 5,365,497, U.S. Pat. No. 3,938,317, U.S. Pat. No. 5,559,761, and Swiss 618827, describes watches designed for telling time by the blind. The three US patents use system of various vibrations to communicate the time. For most professionals holding meetings, learning this code would be a difficult and lengthy process. In addition, there is no way in these watches to program certain meeting times with specific alarm reminders to go off at certain times. The Swiss 618827 patent describes a device worn on the wrist with 4 vibrators distributed in different places. The design communicates time according to which vibrator goes off. The problem with this design is that the device needs to be quite large so that the vibrators are spaced far enough apart for a person to be able to differentiate the different vibrations. The size of this art then makes this device impractical for professionals in meetings.

### SUMMARY OF THE INVENTION

The present invention is a time keeping device in pager-like form, worn on the waist or in one's pocket or on one's wrist as a watch, with the function of providing silent pre-programmed signals via vibration throughout a time interval such as a meeting or speech, so that an individual can track the time without the distraction of looking at a clock or one's watch. The present invention overcomes the problems associated with the prior art by having the ability to be programmed with any time interval. Once this unit is programmed with a specific time interval, it will send a vibration signal to the user at ½way through the interval, at 5 minutes before the end, and at the end of the interval. In addition, each of these vibrations is unique; the signal at ½way through is a short vibration of 4 seconds, the signal at 5 minutes before the end is two vibrations of 4 seconds, with a 4 second space between them, and the signal at the end is one long vibration of 8 seconds. These distinct different vibrations are very easy to learn, and communicate to the user where one is in relation to time left in the time interval.

If the user holds a meeting, gives a talk, or holds a class of the same duration of the first time interval, this invention will automatically reset itself on the next ½hour, or hour, or 2nd hour (depending on the length of the time interval), and then deliver the same vibration signals at the exact same times. For example, when this unit is used for timing a psychotherapist's sessions, the psychotherapist most commonly sets the unit for a 50-minute meeting. This unit will then send the user a vibration signal at 25 minutes after the hour, and at 45 minutes after the hour and at 50 minutes after the hour. Then the unit will automatically begin to time the next psychotherapy session at the beginning of the next hour (i.e. in ten more minutes which is on the hour), without the user needing to do anything. If the user does not have a meeting on the next hour, the user can still keep the unit programmed at the 50-minute session time, but can turn off the vibrating alarm with a mechanical switch on the side of the unit. This way, if a session will be held an hour later, or two hours later, the user can simply click on the mechanical switch to vibrate (this switch can be set to vibrate, off, or beep), and the unit will send the vibration signals at the correct times to the user. If the user does not begin his meetings on the hour, he can program the unit to begin timing the meeting at any time after the hour, and then the unit will stay on this time schedule until a different programming is put in. For example, if one begins a meeting at 15 minutes after the hour, and the meeting is 50 minutes in length, the vibration signals will signal at 40 minutes after the first hour, and then on the hour, and then at 5 minutes after the hour. Then the unit will automatically begin timing the same duration of meeting again at 15 minutes after the hour. If a meeting is ½hour or less, this unit will time the meeting and signal at the three times during the meeting, and then begin again automatically to time the next meeting on the ½hour. If a meeting is more than ½hour and less than or equal to 1 hour, this unit will repeat the timing function every hour. If a meeting time is more than 1 hour and less than or equal to 2 hours, this unit will repeat this same meeting timer function every two hours.

This invention includes a number of other features along with the interval/meeting timer. There is also a standard timer (with optional repeat function), there are 12 programmable alarms in a 24-hour period, and there is a stopwatch function. In addition there is a timer called the Custom Timer. The Custom Timer allows up to 6 unique vibration (or unique beeps) alerts to be programmed anywhere within a countdown time of from 3 seconds to 60 minutes, and this countdown can be set for one countdown, or to repeat over and over, or to count up when countdown is complete. These main five functions; the interval/meeting timer, the timer, the stopwatch, and the 12 alarms/24 hours, and the Custom Timer can each be used on their own, or some functions can be used in concert with each other as follows: This invention is designed so that the 12 alarms/24 hours can be used in concert with any of the other functions so that many types of creative time-management programming can be accomplished. For example, lets say a person wants to give a presentation for 60 minutes and then a question and answer period of 30minutes, and then after the Q/A period, he will give short quiz for 15 minutes. Lets say this person wants to use the interval/meeting timer function for the talk because he will be silently reminded at 3 different times during the talk what the time is, which will help him stay on track during this talk, but then he would like a reminder at 30 minutes after the end of the talk to end the Q/A period and then another reminder at 15 minutes after the end of the Q/A period to wind up the quiz. Using this invention, he can set the interval/meeting timer for 60 minutes, and then he can set two alarms to go off at the time of the end of the Q/A period and at the end of the quiz. All of this programming can easily be done before the talk is begun, so all he needs to do is set the alarm switch to vibration, and the unit will send the vibration signals at the set times. The stopwatch function can also be used in concert with any of the other functions. For example, lets say a person wanted to start the stopwatch at the beginning of work on a particular project, in order to count the time spent on the project, then he could go to another mode, lets say the timer mode, and set it to 30 minutes that he wanted to spend on a certain task on the project; after 30 minutes he would receive an alarm, signaling to shift to another task, but he would still be working on the main project and the stopwatch would still be counting the time for him that he is spending on the main project overall. This particular combination of functions can be useful for all kinds of business people who bill time to customers, but who also need to meet with clients at certain times and could use the stopwatch and timer (or meeting timer) at the same time.

In addition to the five main functions, this invention also includes the following features: The vibration intensity is adjustable with 3 settings of vibration strength (this is very useful because the vibration motor at full power will make some noise, and at the lower settings, the noise is eliminated), the number of beeps and the volume of the beeps are adjustable, and there is a mechanical switch which can be set to vibration, off or beep, so that no matter what is programmed in the unit, the user can simply turn off the alarm and not be bothered by it (in other words, this feature allows one to keep whatever programming they have in the unit from day to day without the alarm signaling at the set times, and it allows one to easily switch from vibration to beep or vice versa when needed).

Most of the prior art include a single programmable silent alarm that possess two main problems; the first is that only one alarm can signal during a meeting, eliminating the ability to track time during a meeting, and secondly, one has to re-set the alarm every time it is to be used. The present invention solves this last problem, of having to reset the alarm each time it is to be used, in two ways. One way is by allowing the interval/meeting times to cycle, or repeat, with the time of day so that a programmed meeting time of 30 minutes for example, keeps cycling every 30 minutes, along with its three alarm signals. The alarm can be turned off, for example, if there is a break or if the alarm is not wanted or needed.

Another problem that the prior art did not solve was providing a simple means of being able to use the watch/timer to track time during different meetings of different lengths, throughout a workday. For example, lets say that a person has a 60-minute meeting with a client at 9 am then a 20 minute meeting with another client at 10 am. Prior art devices would involve a special programming session to prepare for each of these meetings which would be difficult because there would be no time between the two meetings to program it. The present invention solves this problem by allowing the user to program the unit for a 60-minute meeting, and at the same time, program in an alarm (in the alarm mode) to go off at 10:20 a.m. This holds true for people who hold meetings or give presentations of different lengths throughout the day since many alarms can be pre-programmed at one time.

As described previously, this invention includes different types of vibrations to denote different times. Prior art U.S. Pat. No. 5,365,497, U.S. Pat. No. 3,938,317, U.S. Pat. No. 5,559,761 and Swiss 618827 describe different types of vibrations used to communicate time to the blind. These configurations of types of vibrations however, are complex and would be difficult to learn. The present invention solves this problem by keeping the three different types of vibrations the same and simple to learn. For example, this configuration allows a user to learn these signals easily and rapidly, and enables the user to also learn to track the time in a time interval or meeting according to the simple structure of ½time, 5 minutes before the end, and the ending time. Or if the Custom Timer is used, there are six different types of vibration to choose from: a 5 second vibration; a 5 second vibration with a 5 second space and a 5 second vibration; a 10 second vibration; a 10 second vibration with a 7 second space and a 10 second vibration; a 20 second vibration; and a 2 second vibration.

This invention is designed to be easy to use by providing pre-programmed alarm signals which signal at the set times of ½way through, at 5 minutes before the end, and at the end of a time interval, or at anywhere within the time interval the user wants. This should meet the great majority of users needs regarding meeting times, presentation times, and time intervals in which time needs to be tracked. It is designed to suit a wide range of personal needs and sensitivities by providing the adjustable vibration alarm intensity, the optional beeping function, the wearing options, and the custom programming options. In addition, the 12 alarms provide a feature that can be used with the interval/meeting timer or custom timer for creative time management. Finally, the five main modes or functions of the present invention—the timer, the meeting timer, the 12 alarms, the custom timer and the stopwatch when used alone or in combination with each other, provides a technology which solves many time management problems/challenges in today's business and personal worlds.

### BRIEF DESCRIPTION OF THE DRAWINGS

FIG. 1 is a block diagram of the main components of this invention showing how they interface with each other.

FIG. 2 is a block diagram of the basic computer software program used to mask the micro controller chip.

FIG. 3 is a block diagram of the seven modes and their functions of this invention.

FIG. 4 is a block diagram of the Meeting Timer mode.

FIG. 5 is a block diagram of the Custom Timer mode.

FIG. 6 is a circuit diagram of this invention showing the power supply, push buttons, outputs for the buzzer, back light and vibration motor, and the interface with the micro controller and the LCD.

FIG. 7 is a picture of the present invention in pager-like form, showing the front view with the unit inserted into a waist clip.

FIG. 8 is a picture of the present invention in a watch form.

### DETAILED DESCRIPTION OF THE DRAWINGS

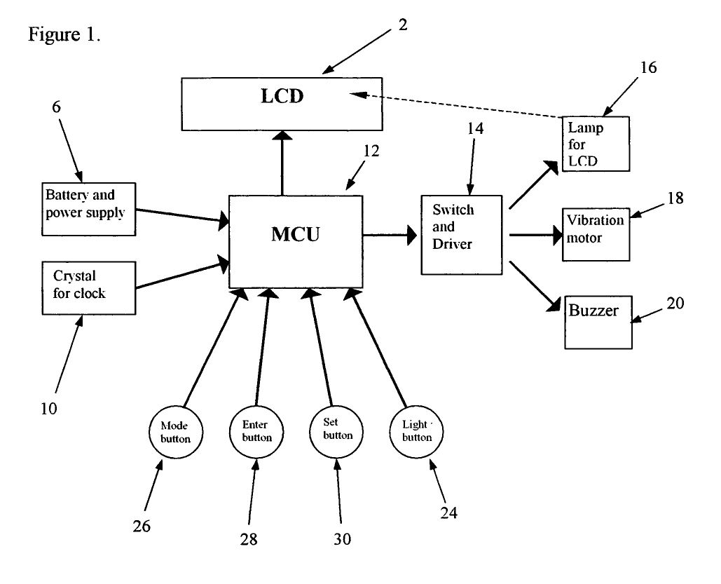

FIG. 1 is a block diagram of the present invention. Micro controller 12 is powered by power supply 6, and is inputted with information from crystal (time and date) 10, switches 24, 26, 28, and 30. Micro controller 12 then outputs the appropriate display to the LCD (liquid crystal display), and outputs signals for the light 16, vibration motor 18, or the buzzer 20. The present invention allows for the MCU 12 to be programmed via buttons 26, 28, and 30 with specific information to run the timer, the meeting timer, the 12 daily alarms, the custom timer, the stopwatch, the vibration and buzzer adjustments, and the time and date adjustments. Switch 14 is an external switch located on the side of the timer unit and is used to set the alarm to vibration, beep or off.

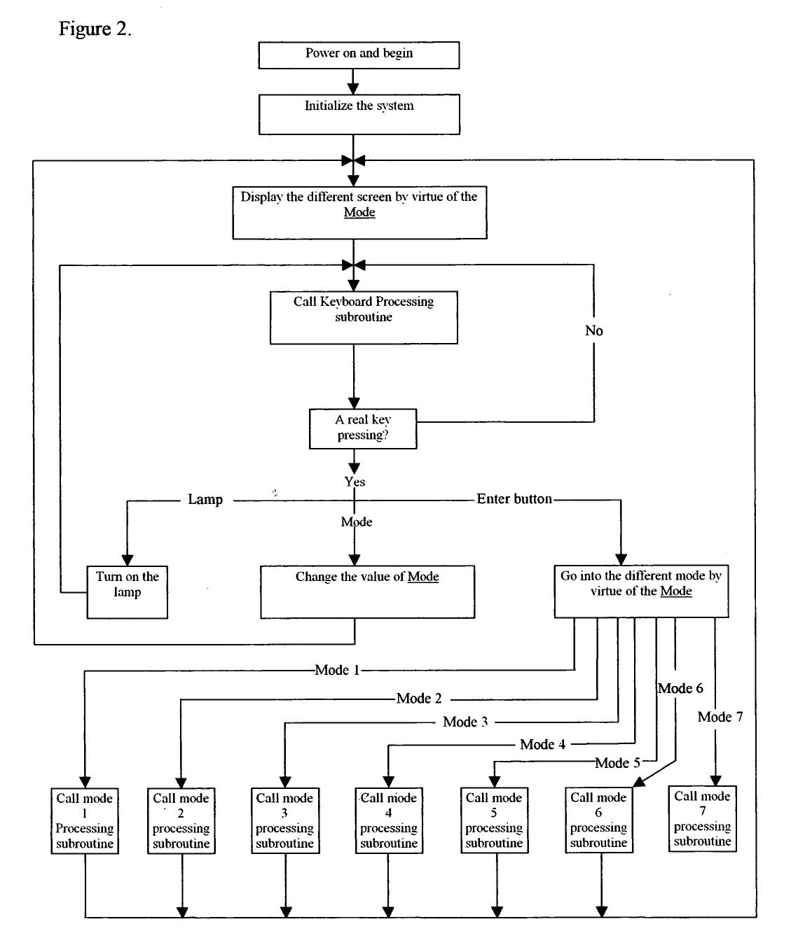

FIG. 2 is a basic diagram of the basic software program of the MCU 12. MCU 12 is pre-programmed (masked) with this software. Buttons 26, 28, the seven modes for programming instructions and undertaking timing and alarm tasks.

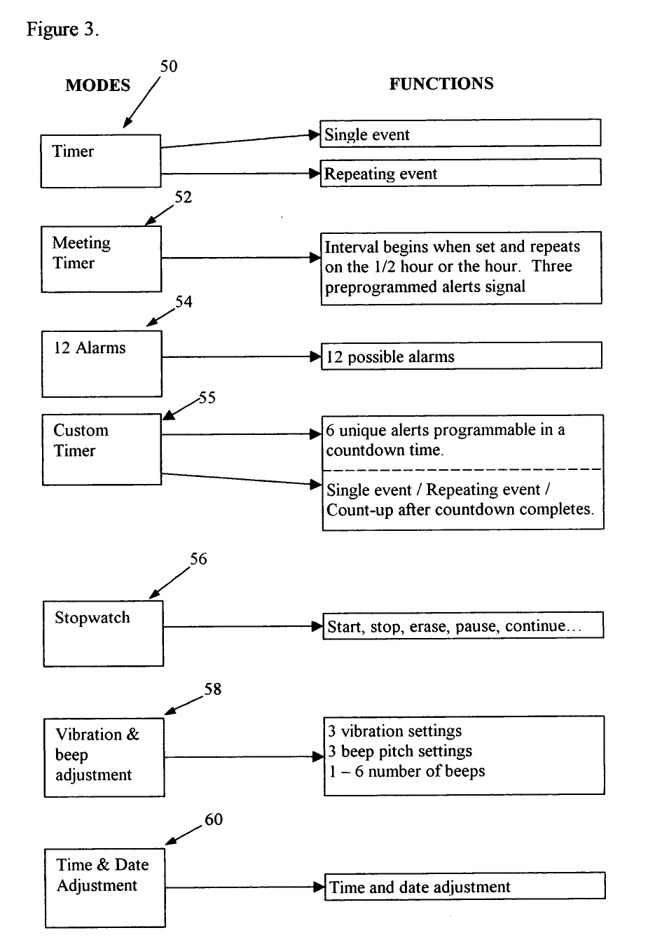

FIG. 3 is a block diagram of the seven modes of the present invention. Timer mode 50 is a standard countdown timer that can be programmed to operate for a single time event or a repeated time event. Meeting Timer 52 can be set to any meeting time between 10 minutes and 120 minutes. When set, the meeting timer will begin will stay on the set time schedule. The Alarms mode 54 allows up to 12 daily alarms to be set in a 24-hour period. Custom Timer 55 allows up to 6 unique vibration or beeping alerts to be set in a countdown event, and allows a single time event, a repeated time event, or a count up when the time event is complete. Stopwatch 56 is a standard stopwatch. It operates when in this mode and it can keep running when not in this mode, so that one can time a certain event, while using the unit simultaneously for another purpose. The vibration and beep adjustment mode 58 is used to adjust the vibration intensity, the beep volume and number of beeps. The time and date mode 60 is used to adjust the time and date.

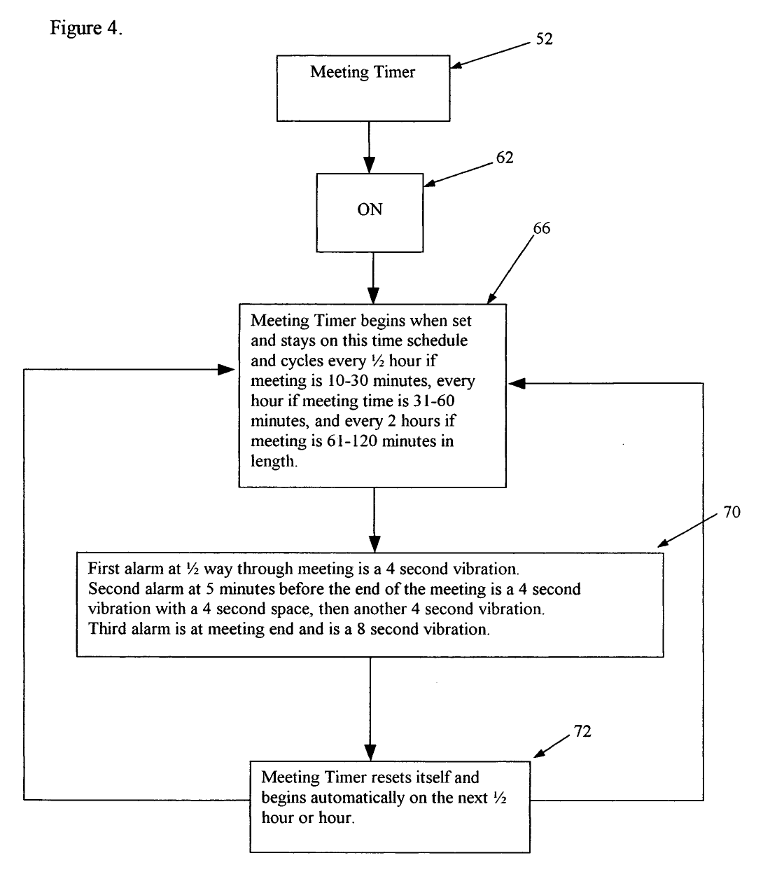

FIG. 4 is a block diagram of the meeting timer 52. In this mode one can program the meeting timer 52 to any time of meeting between 10 minutes and 120 minutes. Once the meeting timer 52 is set, it begins and stays on a ½hour schedule and repeats every ½hour if the meeting time is between 10 and 30 minutes. If the meeting time is between 31 and 60 minutes the meeting timer begins at its set time and repeats every hour. If the meeting time is between 61minutes and 120 minutes, it begins when set and repeats every 2 hours. The vibration alarms 70 of the meeting timer are as follows: The first alarm signals at ½way through a meeting and it is a vibration of 4 seconds; the second alarm signals at 5 minutes before the end of the meeting and it is a 4 second vibration with a 4 second pause and then another 4 second vibration; the third alarm is at the meeting end and it is a 8 second vibration. At the end of the meeting time, the meeting timer begins again automatically 72 on the ½hour, the hour or on the 2nd hour depending on the length of the meeting time. When one leaves the meeting timer mode, this suspends the meeting timer from operating but saves the last meeting time that was programmed.

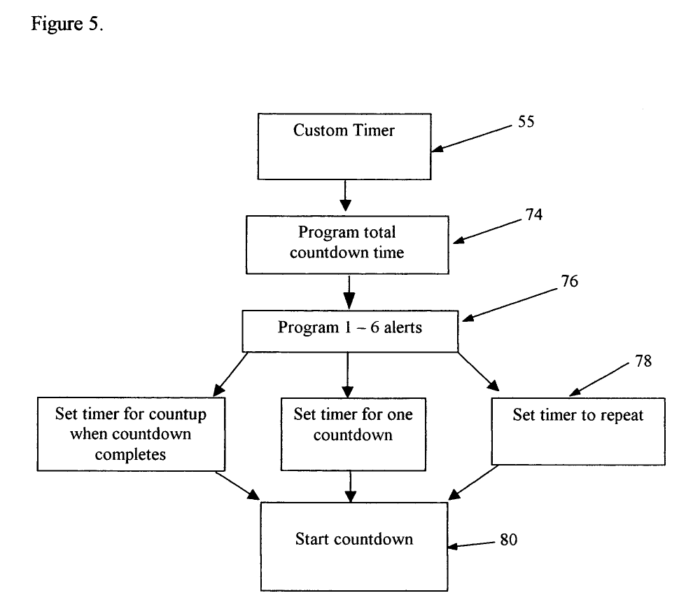

FIG. 5 is a block diagram of the custom timer. You first program the total countdown time, then you program 1 to 6 alerts to signal anywhere within the countdown time. Then you program the timer to go once, or to repeat, or to count up when countdown completes.

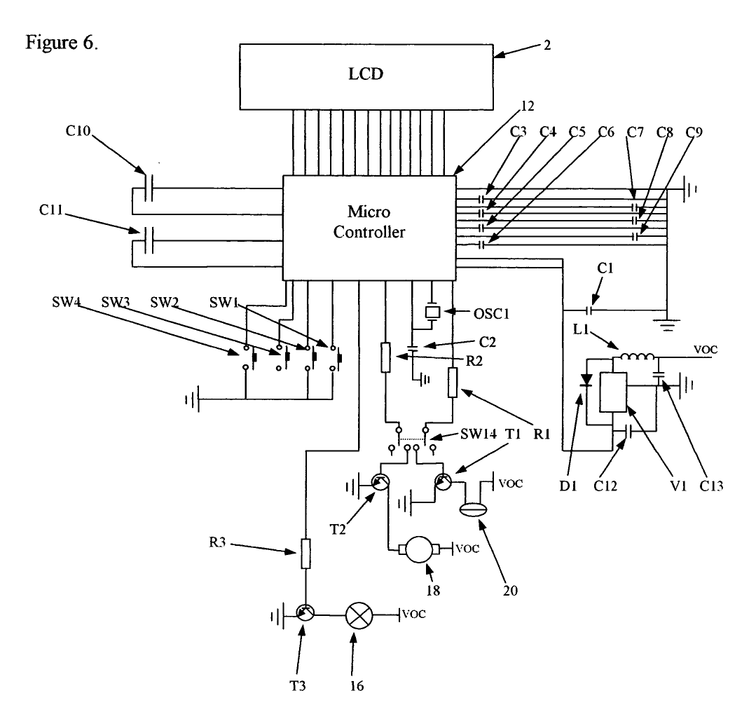

FIG. 6 is a circuit diagram of the present invention. VI is a DC-to-DC voltage multiplier that increases the 1.5 V DC from the battery (one AAA battery, 1.5 V) to 3.3 V for the MCU 12. VI supplies power to MCU 12 only and power to other components comes from the battery directly. The use of high power components such as the vibration motor 18, the buzzer 20, and the LED 16 (backlight) will therefore not cause any adverse effect to MCU 12. When power is on, VI generates 3.3 V DC to MCU 12. Oscillator OSC 1 oscillates and the system generates the RESET signal to start the software, which works as shown in FIG. 2. MCU 12 is a 8-bit micro controller with 640 built-in dot matrixes, which is used as LCD 2 drive; its size is about 5 mm×6 mm after it is masked. Binding technology is used in installation. Power consumption of MCU 12 is low at about 300 uA at a working voltage of 3 V.

LCD 2 adopts the way of STN display. There are 16 COMMONs and 40 SEGMENTs on the LCD 2. Working voltage is 5 V and it is connected to the PCB (printed circuit board).

OSC 1 has a frequency of 32768 Hz with +/×2 Hz, providing accuracy of time measurement to +/×0.5 seconds per day. TI, T2 and T3 are the transistors used to drive signals to the buzzer 20, the vibration motor 18 and the LED 16. Buttons S1 is the “set” button 30, S2 is the “Enter” button 28, S3 is the “Mode” button 26, and S4 is the “Light” button 24. Switch SW 14 is the switch used to switch from silent alarm, to audible alarm, or off. Capacitors C3, C4, C5, C6, C7, C8, and C9 are voltage increases to the LCD 2. Power supply of LCD 2 comes from the power at 5 V generated by the internal circuit of MCU 12. C10 is a biased capacitor to LCD 2. C2 is a fine adjustment capacitor to oscillator OSC 1. C12, C13, L1 and D1 are components to V1, which ensure normal working condition of V1 to increase the voltage. Resistors R1, R2, and R3 are used to limit electric current to transistors T1, T2, and T3.

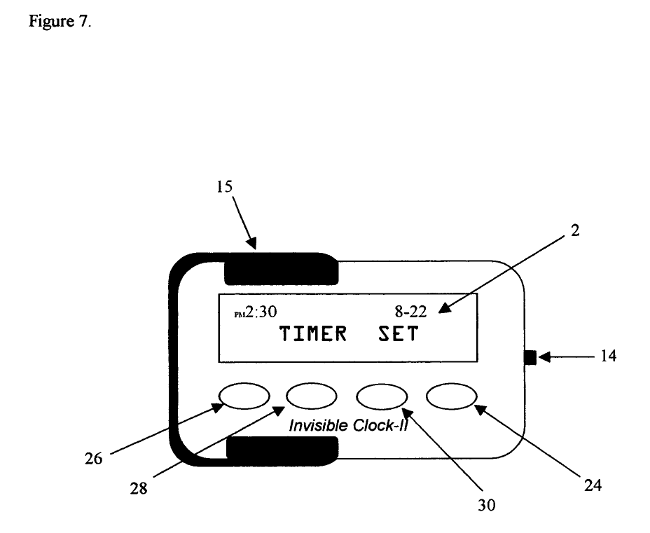

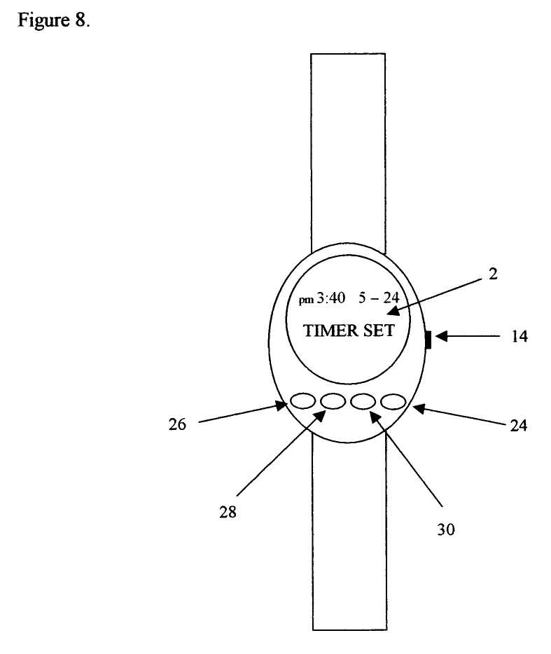

The working voltage and electric current of the vibration system is averaged at 1.5 V and 40 mA respectively. Three different rpm's from the vibration motor are set by adoption of pulse width modulate so as to adjust vibration intensities, and allow for low, medium and high vibration intensities. The working voltage and electric current of the buzzer system is averaged at 1.5V and 40 mA respectively. Three sound frequencies are set through changing tone so as to adjust the volume of sounds and allow for low, medium and high volumes of sound. The working voltage and electric current of the LED for the backlight is averaged at 1.5V and 20 mA respectively. The LED is used to illuminate the LCD 2. FIG. 7 is a picture of the present invention in pager-like form. Front view shows LCD 2, Mode button 26, Enter button 28, the Light button 24 and Set button 30. The side view shows the location of switch 14. Quick removable waist clip 15 is shown installed on the unit. In this embodiment of the present invention, this unit shown is shown in a form similar to a small pager. This form and size (½″×1-½″×2-⅛″) has been chosen for the present invention to allow for the use of one AAA battery to ensure sufficient power, convenience of battery replacement, and economical battery replacement. The present invention can also be used in wristwatch form as shown in FIG. 8.

FIG. 8 shows the present invention is wristwatch form. Buttons 26, 28 and 30 are located on the face of the watch and are Mode, Auto/Man, and Timer buttons, respectively. Light button 24, and switch 14 are located on the side of the watch. The LCD 2 is located in the watch face.

What is claimed is:

1. A timing device enclosed in a housing having within it an electronic circuit, a battery for power, a beeping device, a vibrating device, multiple alarms, multiple timer functions, an adjustment mode, and a liquid crystal display (LCD).

2. A timing device according to claim 1 wherein said number of timer functions includes a meeting timer further comprising the means to provide 3 unique vibrating alerts at preset times according to the time of meeting set by the user.

3. A timing device according to claim 1 wherein said number of timer functions includes a custom timer further comprising the means to provide up to 6 unique vibrating or beeping alerts within a countdown time set by the use.

4. A timing device according to claim 1 wherein said number of multiple alarms includes 12 alarms further comprising the means to provide daily alarms at any time during a 24-hour period.

5. A timing device according to claim 1 wherein said adjustment mode includes a vibration intensity adjustment, a beep intensity adjustment, a vibration duration adjustment and a beep number adjustment.
